(19) United States
(12) Patent Application Publication
(10) Pub. No.: US 2024/0386166 A1
(43) Pub. Date: Nov. 21, 2024

(54) MODELING METHOD FOR ELECTROMAGNETIC FORCE AND VIBRATION OF SURFACE-MOUNTED PERMANENT MAGNET MACHINES

(71) Applicant: JIANGSU UNIVERSITY, Zhenjiang (CN)

(72) Inventors: Wenxiang ZHAO, Zhenjiang (CN); Tong LIU, Zhenjiang (CN); Jinghua JI, Zhenjiang (CN); Donghui CAO, Zhenjiang (CN)

(73) Assignee: JIANGSU UNIVERSITY, Zhenjiang (CN)

(21) Appl. No.: 18/681,093

(22) PCT Filed: Jul. 7, 2023
(86) PCT No.: PCT/CN2023/106215

§ 371 Date: Feb. 5, 2024

(30) Foreign Application Priority Data
May 16, 2023 (CN) 202310551257.5

(51) Int. Cl. G06F 30/23; G06F 30/17; G06F 111/04; G06F 119/14

(52) U.S. Cl. CPC G06F 30/23; G06F 30/17; G06F 2111/04; G06F 2119/14

(57) ABSTRACT

A modeling method for electromagnetic forces and vibration response of a SPM machine, belonging to the field of combined electromagnetic field and structural mechanics computation. First, build the circuit-based EMN model, regular EMN model, and discrete EMN model with equivalent magnetic source and permeance for the different regions of the SPM machine. Second, based on the spatial relationships between each part in the SPM machine, the EMN models of each region are interconnected to form a complete model of the discrete EMN model. The non-sinusoidal high-frequency current harmonics are introduced as input excitation to the discrete EMN model. The global nonlinear matrix equation is solved simultaneously to determine the magnetic flux density in the air gap permeance elements, enabling the air gap electromagnetic force density calculation. Subsequently, the calculated electromagnetic force density is transformed into concentrated forces on the surface of the stator teeth.

### CROSS REFERENCE TO RELATED APPLICATION

This application is a national stage entry of International Application No. PCT/CN2023/106215, filed on Jul. 7, 2023, which is based upon and claims foreign priority to Chinese Patent Application No. 202310551257.5, filed on May 16, 2023, the entire contents of which are incorporated herein by reference.

### TECHNICAL FIELD

The present invention relates to a combined computational technology of electromagnetic fields and structural mechanics, and specifically to a method for modeling electromagnetic force and vibration in a surface-mounted permanent magnet machines based on discrete equivalent magnetic network and vibration transfer function.

### BACKGROUND

Due to its high power density and dynamic advantages, the surface-mounted permanent magnet (SPM) machine is widely used in servo systems. The vibration issues of the motor directly determine its operational smoothness and service life. Especially under non-sinusoidal excitations, complex and rich high-frequency electromagnetic force harmonics exist within the surface-mounted permanent magnet synchronous motor, exacerbating the vibration performance of motors. Solving the electromagnetic force and structural response is the key to vibration analysis of the SPM machines. Traditional vibration calculation methods combine two-dimensional and three-dimensional finite element analysis (FEA) to distribute the computation of electromagnetic forces and vibration responses. However, this approach is time-consuming due to the requirement for many mesh divisions.

As a magnetic field solution, the equivalent magnetic network (EMN) method offers advantages such as simple modeling and fast solving speed. Nevertheless, traditional EMN methods rely on variations in the connectivity of magnetic flux nodes at junction interfaces to approximate the motor's rotational steps. This poses severe limitations in high-frequency magnetic field calculations with minimal solution steps, making it challenging to efficiently compute the magnetic field within the motor under non-sinusoidal excitations. Discretizing the rotor region of the SPM machine and replacing the traditional node connection changes in equivalent magnetic potential within each discrete element makes it possible to calculate transient magnetic fields and electromagnetic forces at arbitrary solution step sizes. Combining the discrete EMN method with the vibration transfer functions based on the frequency modal superposition method enables a rapid assessment of the vibration response of the SPM machine in the early design stages.

### SUMMARY

An objective of the present invention is to present a method for modeling electromagnetic force and vibration in the SPM machine based on discrete EMN and vibration transfer functions. The proposed method primarily includes the magnetic path permeance equivalence in the regular magnetic flux line region, modeling of the air-gap triangular permeance, discretized modeling of the rotor region, and the establishment and solution of vibration transfer functions based on the frequency domain modal superposition method. By employing the discretized EMN model, the calculation of the electromagnetic force density of the SPM machine under non-sinusoidal excitations is accomplished. Additionally, a vibration calculation model for the SPM machine is established by utilizing vibration transfer functions, enabling the solution of vibrations across the entire frequency spectrum under non-sinusoidal excitations.

To achieve the objectives mentioned above, the technical solution adopted by the present invention is a method for modeling electromagnetic force and vibration in the SPM machine based on discrete EMN and vibration transfer functions, including the following steps:

Step 1: Establishing a periodic mixed EMN model for the stator core, uniform air-gap region, and slot locations based on the magnetic symmetry characteristics of the SPM machine.

Step 2: Establishing a periodic discrete EMN model for the rotor core, permanent magnet, and uneven air-gap regions based on the magnetic symmetry of the SPM machine.

Step 3: Connecting the periodic mixed EMN model with the periodic discrete EMN according to node mapping principles, setting physical boundary conditions for nodes at periodic boundaries, introducing non-sinusoidal high-frequency current harmonics as the input excitation of the EMN model, and establishing and solving the global nonlinear matrix equation.

Step 4: Calculating the electromagnetic force density in the air gap of the SPM machine using the radial and tangential magnetic flux densities of each permeance of the EMN model in the air-gap, and transfer these forces densities to concentrated forces acting on the stator teeth based on force transformation principles.

Step 5: Solving the specific order modal shapes and modal frequencies of the stator core, winding, and casing structure, and construct the frequency response function of the SPM machine, whose orders are the same as the main electromagnetic force harmonic orders of the SPM machine.

Step 6: Establishing the constraints of the SPM machine, apply the unit-wave concentrated forces with the main harmonic orders on the circumferential surface of the stator teeth, solve for the vibration displacement at surface measurement points, and construct the static displacement function of the SPM machine.

Step 7: Multiplying the frequency response function of the SPM machine by the static displacement function according to corresponding orders to obtain the vibration transfer function of the SPM machine.

Step 8: Incorporating the concentrated electromagnetic forces obtained from the discrete EMN model into the vibration transfer function of the SPM machine to solve the vibration displacement, velocity, and acceleration at measurement points on the surface of the SPM machine.

Furthermore, in Step 1, the SPM machine in the present invention is a three-phase 12-slot/10-pole SPM machine with eccentric permanent magnet, consisting of the stator, air-gap, rotor, and casing. The stator includes the stator yoke, stator tooth, stator pole shoe, and the phase winding in the slot. The stator core material is a non-oriented silicon steel sheet DW310-50, and the winding is a fractional slot concentrated winding with temperature-resistant varnish-covered wire. The air-gap is an irregular air region between the stator teeth and the rotor permanent magnet surface, with a length of 1 mm. The rotor consists of a rare-earth permanent magnet and rotor core, with the permanent magnet being an N42UH surface-mounted eccentric permanent magnet on the rotor core surface. The rotor core is made of the non-oriented silicon steel sheet DW310-50, laminated and perforated on the circumference to reduce weight. The casing is made of aluminum alloy, fitting snugly with the stator, and has a cylindrical shape. The shaft is made of non-magnetic material, stainless steel 304, solid cylindrical, and coaxially connected with the rotor.

Furthermore, in Step 1, based on the slot-pole combination and magnetic circuit characteristics of the SPM machine, determine the distribution of magnetic flux lines. The number of symmetric magnetic circuits of the SPM machine is calculated based on the slot-pole combination, determining a complete magnetic circuit region in the stator, air gap, permanent magnet, and rotor areas. The circuit-based permeance method is established for the stator yoke area between every two stator teeth in a complete magnetic circuit region. The stator tooth area is divided using rectangular permeance, and the stator pole shoe area and the slot area between two pole shoes are modeled using a combination of rectangular and triangular permeances.

Furthermore, in Step 2, the specific process of establishing the periodic discrete EMN model for the rotor core, permanent magnet, and uneven air-gap regions is as follows: Based on the distribution of a complete magnetic circuit in the SPM machine, determine the modeling regions for the air gap, permanent magnet, and rotor core. Divide the irregular air gap and permanent magnet regions into three areas: Area 1 is a regular annular region from the stator tooth surface to the highest point on the permanent magnet surface, Area 2 is the permanent magnet and the gap region between them, and Area 3 is the rotor core region. For Area 1, use a size-variable isosceles triangle permeance element for at least four subdivision layers, with triangles arranged alternately. For Area 2, use the rectangular permeance element to mesh, consisting of one permeance and one equivalent magnetic potential source. The value of the equivalent magnetic potential source is determined by the effective height of the permanent magnet in this region at different solving times. For Area 2, divide it using the permeance element, with the width of each permeance element matching the rectangular permeance element in Area 2 and each permeance element consisting of two permeances in a series.

Furthermore, in Step 3, the establishment and solution of the global nonlinear matrix equation is as follows: Connect the nodes of the permeance in the circumferential direction of the stator yoke in sequence according to the tangential arrangement, connecting these nodes with the corresponding uppermost permeance nodes in the stator tooth area below. Connect the permeance element in the stator tooth area within the core region in sequence, selecting the upper and lower nodes in the middle position as equivalent winding magnetic potential source nodes. Connect the lowermost permeance node in the stator tooth area to the uppermost permeance node at the pole shoe. Connect the permeance nodes at the stator tooth surface to the multi-layer triangular permeances in the uniform air gap region. Connect the lowermost permeance in the uniform air gap region to the discretized permeance region of the rotor. Establish a solution matrix based on the number of permeances of the discrete EMN model and connectivity of the overall model, determining the labels for the iron core region requiring permeance update calculations.

Furthermore, in Step 4, based on the solution results of the overall magnetic network model, obtain the magnetic flux density of each layer of permeances in the uniform air gap region. Select one layer of permeance and, according to the magnetic density values of the three permeances in each triangular element and their geometric spatial positions, calculate the equivalent radial and tangential magnetic densities for each triangular element using the vector addition principle. Calculate the radial and tangential electromagnetic force densities along the circumference of the air gap based on Maxwell's stress tensor equation. Apply the electromagnetic force transfer model to convert the calculated node electromagnetic force density into concentrated radial and tangential forces and equivalent moment acting on the stator tooth surface.

Furthermore, in Step 5, based on the electromagnetic topology design parameters and mechanical structure design parameters of the SPM machine, establish a structural model considering actual motor installation conditions, including the stator core and casing. Calculate the stator Young's modulus, Poisson's ratio, and equivalent density under orthogonal anisotropy based on the thickness of the stator silicon steel sheet. Treat the phase winding as an additional mass attached to the stator core, considering the influence of winding impregnation on the stator stiffness. Conduct a modal analysis of the constructed structural model, calculate modal orders and their modal frequencies, and construct the frequency response function of the SPM machine.

Furthermore, in Step 6, based on the spatial position angles of each centerline in the stator, construct concentrated forces of amplitude IN for the main orders in the radial and tangential directions, and a moment of amplitude 1 N.m. Apply these forces and moment individually to each tooth surface of the stator. Set constraint conditions based on actual installation constraints of the SPM machine and solve for the static deformation at the axial centerline of the casing under the action of each concentrated force and moment. Divide the obtained static deformation distributed by spatial position by the applied unit excitation to obtain the static deformation function for each order force and moment.

Furthermore, in Step 7, multiply the frequency response and static deformation function obtained in Steps 5 and 6 for each order to obtain the vibration transfer function from concentrated forces and moment to the surface vibration of the casing of the SPM machine.

Furthermore, in Step 8, substitute the radial and tangential concentrated electromagnetic forces and the moment obtained in Step 5 into the vibration transfer function obtained in Step 7. This allows the calculation of the surface vibration displacement of the casing in the frequency domain of the SPM machine. Based on the conversion relationship between frequency domain displacement, vibration velocity, and vibration acceleration, calculate the vibration acceleration of the SPM machine, completing the vibration calculation.

The present invention has the following beneficial effects:
1. The use of the variable-sized triangular permeance element for the air gap region in the present invention better conforms to the complex magnetic field distribution in the air gap during the actual operation of the SPM machine, improving the accuracy of EMN model calculations.
2. The adoption of periodic solution techniques in the present disclosure, based on the slot-pole combination of the SPM machine, determines a single symmetric module region for modeling, reducing the computational costs of the EMN model and improving efficiency.
3. For modeling the rotor and stator core of the SPM machine, the present disclosure adopts a discretization approach, equivalently converting changes in the magnetic potential of the discrete units in the permanent magnet and rotor core into the rotational operation of the SPM machine. This allows for arbitrary step-length solutions, meeting the rapid solution requirements for high-frequency magnetic fields under non-sinusoidal excitations of the SPM machine.
4. The electromagnetic force density in the air gap is obtained by vector addition calculations of the magnetic flux densities of various parts of the triangular permeance element, avoiding errors from individual permeance calculations and enhancing the accuracy of electromagnetic force calculations.
5. The combination of the discrete EMN model and vibration transfer functions in the present invention allows for quick and efficient vibration calculations of SPM machines. This is advantageous for rapidly assessing the electromagnetic and vibration performance of the SPM machines under different operating conditions.
6. The method in the present invention combines the static deformation function and frequency response function, considering the impact of radial and tangential forces, as well as equivalent moment, on the vibration of the SPM machine. This enhances the accuracy of motor vibration calculations.

### BRIEF DESCRIPTION OF THE DRAWINGS

FIG. 1 shows the 2D model of the 12-slo/10-pole SPM machine used in the present invention;

FIG. 2 shows the magnetic flux line distribution under load conditions of the SPM machine in the present invention;

FIG. 3 shows the hybrid EMN model diagram of the stator and air gap regular regions for the SPM machine used in the present invention;

FIG. 4 shows the schematic diagram of the variable-sized isosceles triangle permeance element used for modeling air gap regular regions in the present invention;

FIG. 5 shows the schematic diagram of modeling area division for rotor and air gap regions of the SPM machine used in the present invention;

FIG. 6 shows the schematic diagram of the discrete EMN model for the rotor and irregular air gap regions of the SPM machine used in the present invention;

FIG. 7 shows the schematic diagram of magnetic flux density variation for each discretized unit in the rotor region during the transient calculation of the SPM machine used in the present invention;

FIG. 8 shows the hybrid periodic EMN model for the stator and air gap regular regions of the SPM machine used in the present invention;

FIG. 9 shows the vector synthesis diagram of radial and tangential magnetic flux densities for the isosceles triangle permeance element used in the present invention;

FIG. 10 shows the comparative diagram of radial and tangential magnetic flux densities in the air gap calculated by the present discrete EMN model and FEA method;

FIG. 11 shows the comparative diagram of two-dimensional Fourier decomposition results of low-frequency and high-frequency electromagnetic force densities calculated by present discrete EMN model and FEA method;

FIG. 12 shows the excitation method and vibration results diagram for second-order unit excitation used in constructing static displacement function in the present invention;

FIG. 13 shows the schematic diagram of the second-order static displacement function constructed for the SPM machine used in the present invention;

FIG. 14 shows the schematic diagram of the vibration transfer function constructed for the SPM machine used in the present invention;

FIG. 15 shows the comparative schematic diagram of vibration acceleration of the SPM machine in the present invention with FEA and experimental results;

FIG. 16 shows the modeling and calculation flowchart of the combined discrete EMN model and vibration transfer function in the present invention.

### DETAILED DESCRIPTION OF THE EMBODIMENTS

The following will provide a clear and complete description of the technical solution in the embodiments of the present invention in conjunction with the accompanying drawings in the embodiments of the present invention.

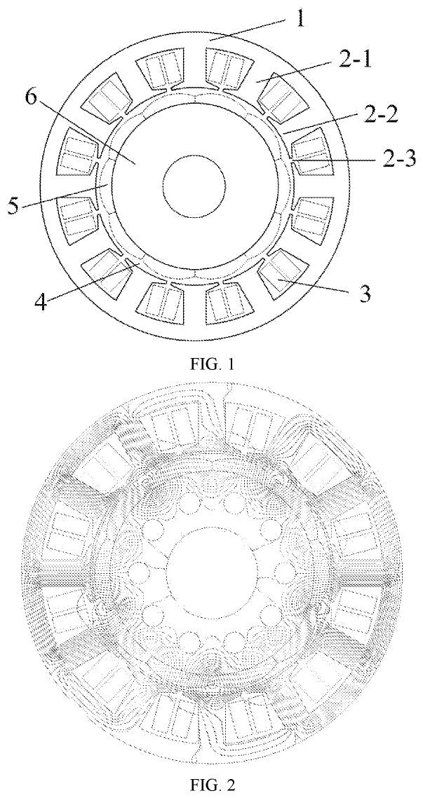

To illustrate the beneficial effects of the present invention more clearly and understandably, a specific surface-mounted permanent magnet motor will be described in detail as follows: FIG. 1 shows the 2-D model of the 12-slot/10-pole SPM machine, where 1 is the stator core yoke, 2-1 is the stator core tooth, 2-2 is the stator core tooth pole shoe, 2-3 is the air gap between the pole shoes of the stator core tooth, 3 is the stator armature winding, 4 is the air gap, 5 is the eccentric permanent magnet, and 6 is the rotor core. The SPM machine in the present invention is a three-phase 12-slot/10-pole SPM machine with eccentric permanent magnet, consisting of the stator, air-gap, rotor, and casing. The stator includes the stator yoke, stator tooth, stator pole shoe, and the phase winding in the slot. The stator core material is a non-oriented silicon steel sheet DW310-50, and the winding is a fractional slot concentrated winding. The air gap is an irregular air region between the stator teeth and the rotor permanent magnet surface, with a length of 1 mm. The rotor consists of permanent magnets and rotor core. The surface-mounted permanent magnet is eccentrically shaped in an arc, arranged on the surface of the rotor shaft with opposite polarities, and the pole arc coefficient of the permanent magnet is 1. The rotor core is made of the non-oriented silicon steel sheet DW310-50, laminated and perforated on the circumference to reduce weight. The shaft is made of non-magnetic material, stainless steel 304, solid cylindrical, and coaxially connected with the rotor.

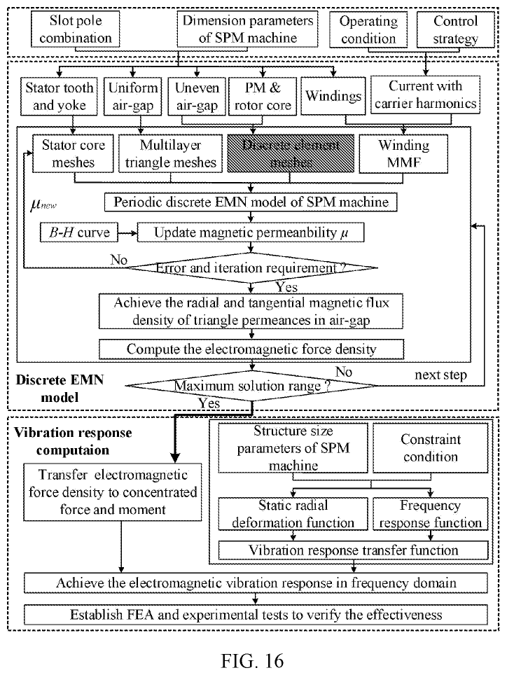

The flowchart as shown in FIG. 16 is divided into the following steps for implementation:

Step 1: Establish a mesh-based EMN model for the stator core, uniform air gap region, and stator core opening regions based on the magnetic symmetry characteristics of the SPM machine.

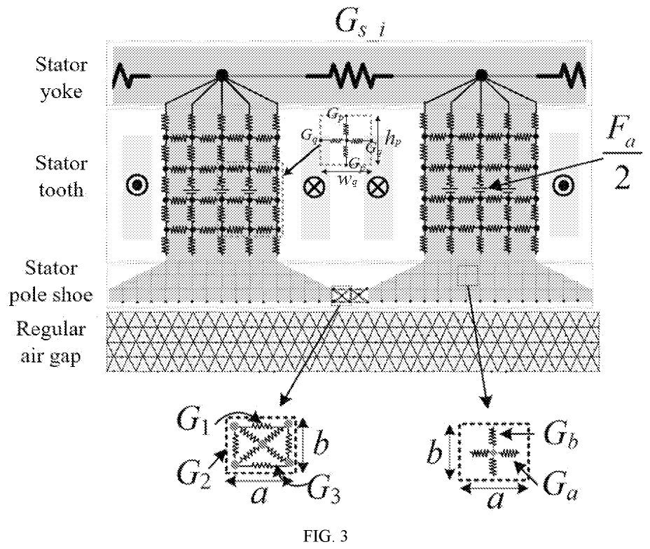

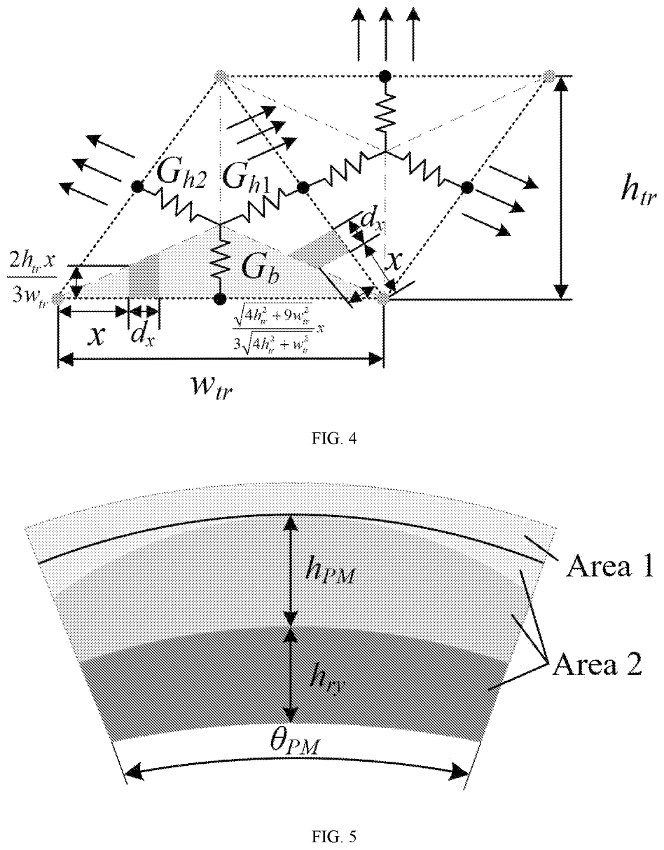

FIG. 2 illustrates the magnetic flux lines analysis of the SPM machine of the present invention. FIG. 3 depicts the hybrid EMN model for the stator, uniform air gap region, and stator core opening areas of the SPM machine, while FIG. 4 shows the isosceles triangle permeance element used to segment the uniform air gap region in the present invention. It can be observed that the distribution of magnetic field lines in the stator yoke 1 and tooth 2-1 is relatively uniform within the motor. However, in the stator pole shoe 2-2 and air gap 4, the distribution is more complex, with a significant amount of leakage flux and harmonic content. For each complete magnetic circuit area between every two stator teeth, the stator yoke 1 is established based on the magnetic circuit method; the stator tooth portion 2-1 is segmented using rectangular magnetic guiding elements. The slot area 2-3 between the stator pole shoe 2-2 and the two stator pole shoes is modeled with a combination of rectangular and triangular permeance elements. Each isosceles triangle permeance element is divided into G_{b}, Gₕ₁, and Gₕ₂, based on the lines connecting the center and midpoints of the three sides. Here, G_{b} represents the permeance at the center and midpoint of the base of the isosceles triangle, while Gₕ₁ and Gₕ₂ represent the permeances at the center and midpoints of the two legs, respectively. The calculation formula is as follows:

$$\begin{matrix}{G}_{h 1} = {G}_{h 2} = 2 {\int }_{\frac{\sqrt{4 {h}_{tr}^{2} + {w}_{tr}^{2}}}{3}}^{\sqrt{4 {h}_{tr}^{2} + {w}_{tr}^{2}}} {μ}_{0} {μ}_{r} {L}_{a} \frac{3 \sqrt{4 {h}_{tr}^{2} + {w}_{tr}^{2}}}{x \sqrt{4 {h}_{tr}^{2} + 9 {w}_{tr}^{2}}} dx \\ \approx \frac{6 {μ}_{0} {μ}_{r} {L}_{a} \sqrt{4 {h}_{tr}^{2} + {w}_{tr}^{2}}}{\sqrt{4 {h}_{tr}^{2} + 9 {w}_{tr}^{2}}}\end{matrix} \qquad ( 1 )$$

$${G}_{b} = 2 {\int }_{\frac{{w}_{tr}}{6}}^{\frac{{w}_{tr}}{2}} {μ}_{0} {μ}_{r} {L}_{a} \frac{3 {w}_{tr} dx}{2 {h}_{tr} x} \approx \frac{3 {μ}_{0} {μ}_{r} {w}_{tr} {L}_{a}}{{h}_{tr}} \qquad ( 2 )$$

where μₒ and μᵣ represent the vacuum permeability and relative permeability, respectively, wₜᵣ and hₜᵣ denote the width of the triangle's base and the triangle's height, and Lₐ represents the axial length of the motor.

The permeance G_{s_i} of the stator yoke part 1 is composed of the elements between the centers of two teeth. The permeances (Gₚ and G_{q}) of the stator tooth part 2-1 comprises rectangular permeance elements. The permeances (Gₐ and G_{b}) of the stator pole shoe 2-2 comprises Gₐand G_{b}. The permeance at the stator pole shoe slot 2-3 comprises crossed rectangular permeance elements represented by G₁, G₂, and G₃. Specifically, G_{s_i}, Gₚ, G_{q}, Gₐ, G_{b}, G₁, G₂ and G₃ are:

$${G}_{s \_ i} = {μ}_{0} {μ}_{r} \frac{{L}_{a}}{{θ}_{ry}} ln \frac{{R}_{ry 2}}{{R}_{ry 1}} \qquad ( 3 )$$

$${G}_{p} = 2 {μ}_{0} {μ}_{r} {L}_{a} \frac{{w}_{q}}{{h}_{p}} \qquad ( 4 )$$

$${G}_{q} = 2 {μ}_{0} {μ}_{r} {L}_{a} \frac{{h}_{p}}{{w}_{q}} \qquad ( 5 )$$

$${G}_{a} = {G}_{1} = {μ}_{0} {μ}_{r} {L}_{a} \frac{2 b}{a} \qquad ( 6 )$$

$${G}_{b} = {G}_{2} = {μ}_{0} {μ}_{r} {L}_{a} \frac{2 a}{b} \qquad ( 7 )$$

$${G}_{3} = {μ}_{0} {μ}_{r} {L}_{a} \frac{b}{\sqrt{{a}^{2} + {b}^{2}}} \qquad ( 8 )$$

where a and b represent the width and height of the rectangular element, respectively. R_{ry1} and R_{ry2} are the radii of the inner and outer circles of the stator yoke part, and θ_{ry2} represents the pole shoe span. w_{q} and hₚ represent the width and height of the rectangular element, respectively.

Step 2: Establish a periodic discrete EMN model for the rotor core, permanent magnet, and uneven air gap region of the SPM machine based on the symmetry of the magnetic circuit.

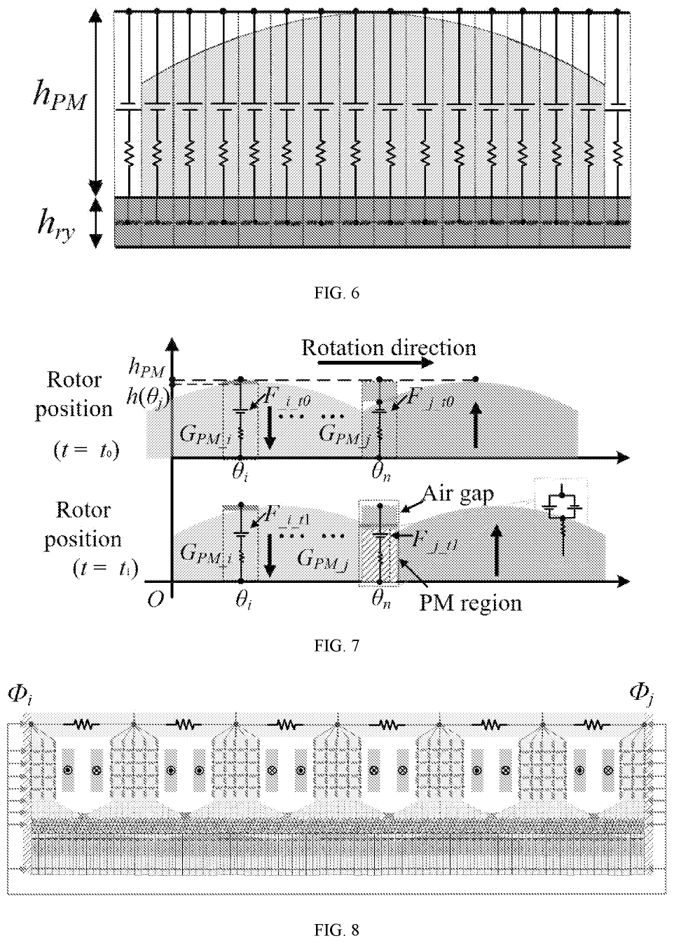

FIG. 5 illustrates the region division for the discrete EMN model of the rotor area, while FIG. 6 provides a schematic representation of the discrete EMN model for the motor's rotor area. Divide the irregular air gap and permanent magnet (Region 5) into three areas: Area 1 is a regular annular region from the stator tooth surface to the highest point on the permanent magnet surface, Area 2 is the permanent magnet and the gap region between them, and Area 3 is the rotor core region. For Area 1, use a size-variable isosceles triangle permeance element for at least four subdivision layers, with triangles arranged alternately. For Area 2, use the rectangular permeance element to mesh, consisting of one permeance and one equivalent magnetic potential source. The value of the equivalent magnetic potential source is determined by the effective height of the permanent magnet in this region at different solving times. For Area 3, divide it using the permeance element, with the width of each permeance element matching the rectangular permeance element in Area 2 and each permeance element consisting of two permeances in a series.

Each discrete permeance in the uneven gap region and eccentric magnet is considered as a unit. The magnetic potential of each element can be determined using the effective magnetization length. The permeance and magnetic potentials of discrete elements can be expressed as follows:

$${G}_{PM \_ i} = \frac{{μ}_{0} {μ}_{r} {L}_{a} {D}_{airgap}}{{N}_{airgap} {h}_{PM}} \qquad ( 9 )$$

$${G}_{ry \_ i} = \frac{2 {μ}_{0} {μ}_{r} {L}_{a} {N}_{airgap} {h}_{ry}}{{D}_{airgap}} \qquad ( 10 )$$

$${F}_{PM \_ i} ( θ , t ) = {Hh}_{PM \_ i} ( θ , t ) \qquad ( 11 )$$

where G_{PM_i} represents the permeance of the i^{th}-discrete element in the permanent magnet and non-uniform air gap region, G_{ry_i} represents the permeance of the i^{th}-discrete element in the rotor core region, F_{PM_i} (θ,t) represents the magnetic potential of the i^{th}-discrete element in the permanent magnet and non-uniform air gap region, D_{airgap} and N_{airgap} represent the circumference and the number of discrete units in the air gap, respectively. h_{PM} represents the thickness of the permanent magnet, h_{ry} represents the thickness of the rotor yoke region, H is the magnetic field strength of the permanent magnet, h_{pm_i}(θ,t) represents the height of the permanent magnet corresponding to the i^{th}-discrete unit at time t, θ is the spatial position of the permanent magnet, and t represents time.

Step 3: According to the node mapping principle, connect the periodic mixed EMN model with the periodic discrete EMN model to establish and solve the global nonlinear matrix equation.

FIG. 7 illustrates the schematic diagram of the variation of the effective magnetic potential with the rotation of the rotor in the discrete elements of the rotor region in the present disclosure. In the present disclosure, the bottom layer of the air gap uniform region and the discrete modeling region of the rotor use the same number of mesh arrangements, enabling a one-to-one correspondence of nodes. The advantage of the present invention lies in that once the discrete EMN model is established, the permeance connection relationships between each element do not need to be changed. Only by changing the assignment of the effective magnetic potential F_{PM_i} for each discrete element of the rotor according to the motor's rotation speed and then performing matrix iteration calculations can the complete calculation be achieved. As shown in FIG. 7, when the discrete element contains two permanent magnets of opposite polarity, the effective magnetic potential can be calculated at the synthesis potential at the key calculation points of the parallel connection of the power source.

FIG. 8 is a schematic diagram of the complete periodic discrete EMN model established for the 12-slot/10-pole SPM machine in the present invention. Since the greatest common divisor of the number of slots and poles of the 12-slot/10-pole SPM machine is 2, a complete machine can be divided into two periodic parts according to the symmetry principle. Each model contains six stator slots and five rotor poles. The principle of applying positive and negative cyclic symmetrical conditions on both sides of the periodic model of the motor can be expressed as:

$${Φ}_{i} = {Φ}_{j} = ( {F}_{i} - {F}_{j} ) {G}_{ij} \qquad ( 12 )$$

$$and$$

$${Φ}_{i} = {Φ}_{j} = ( {F}_{i} + {F}_{j} ) {G}_{ij} \qquad ( 13 )$$

where Φᵢ is the magnetic flux at node i, Φⱼ is the magnetic flux at node j, Fᵢ is the magnetic potential at node i, Fⱼ is the magnetic potential at node j, and Gᵢⱼ is the magnetic conductance connecting nodes i and j.

According to the nodal magnetic flux law in the magnetic field, the permeance matrix G, magnetic potential matrix F, and magnetic flux matrix Φ are combined to establish the permeance solution matrix equation, and the calculation formula is as follows:

$$G \cdot F = Φ \qquad ( 14 )$$

where the magnetic potential matrix F in the equation includes the equivalent magnetic potential of each discrete element in the rotor region and the winding magnetic potential, for the winding magnetic potential, when the current amplitude is 0 under no-load conditions, the corresponding winding magnetic potential is also 0. When loaded, its calculation formula is:

$$F = NI \qquad ( 15 )$$

where N is the number of turns per phase winding, and I represents the injection of non-sinusoidal high-frequency current harmonic data into the winding.

To consider the nonlinear variation characteristics of the permeance in the stator core region, the B-H curve parameters of the stator core, adopted by the 12-slot/10-pole SPM machine, are introduced. The permeability is calculated by interpolation of the B-H curve, which can be expressed as:

$$\{ \begin{matrix}H = {H}_{n} + ( {H}_{n + 1} - {H}_{n} ) \frac{B - {B}_{n}}{{B}_{n + 1} - {B}_{n}} \\ {μ}_{new} = \frac{B}{H}\end{matrix} \qquad ( 16 )$$

where H is the magnetic field strength, Hₙ is the magnetic field strength at the nth iteration, Hₙ₊₁ is the magnetic field strength at the (n+1)^{th} iteration, B is the magnetic flux density, Bₙ is the magnetic flux density at the nth iteration, Bₙ₊₁ is the magnetic flux density at the (n+1)^{th} iteration, and μ_{new} is the permeability obtained new magnetic flux density.

Further solving the matrix equation, select the item with the maximum error in magnetic density between the calculated permeance in the iron core region and the previous calculation as the convergence judgment criterion. When the difference between two iterative calculations is less than 0.005, it can be considered that the iteration has converged. Update the rotor position, and calculate the matrix equation for the next rotor position angle. After one electrical angle cycle calculation, obtain the magnetic potential at each node in the equivalent magnetic network. Further calculate the magnetic flux density on the permeance between nodes with the following formula:

$${B}_{ij} = \frac{( F ( i ) - F ( j ) ) \times G ( i , j )}{S} \qquad ( 17 )$$

where B represents the magnetic induction intensity of permeance between nodes i and j, F(i) is the magnetic potential at node i, F(j) is the magnetic potential at node j, G(i,j) is the permeance between nodes i and j, and S is the cross-sectional area of the magnetic field flow direction.

Step 4: Calculate the magnetic flux density of each permeance element in the air gap based on the segmented magnetic network in the air gap, and transfer the electromagnetic force density in the air gap of the SPM machine to concentrated forces acting on the stator tooth surface, following the principle of force transformation.

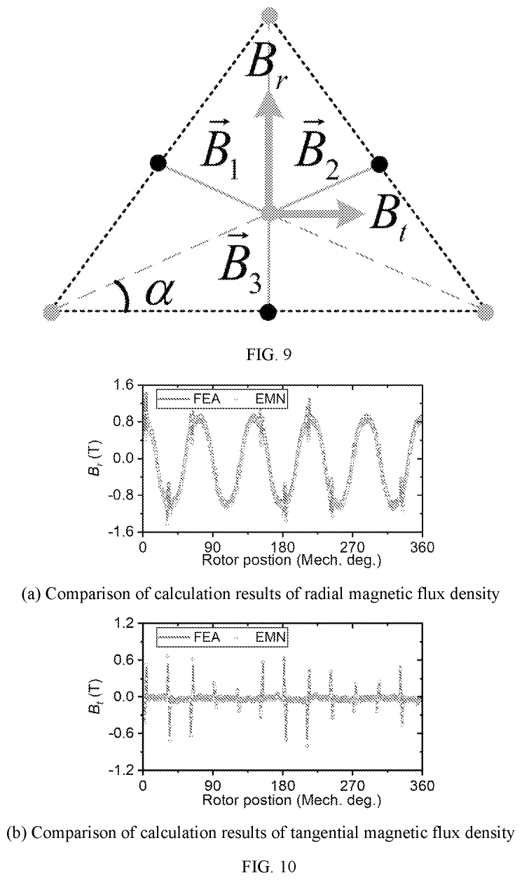

FIG. 9 illustrates the vector synthesis of radial and tangential magnetic flux densities for the proposed isosceles triangle permeance element in the present invention. After calculating the discrete EMN model for one complete electrical cycle, the radial and tangential magnetic flux densities can be obtained by vector synthesis of the magnetic flux densities of the three permeance elements in the middle layer of the air gap at each moment, which can be expressed as:

$${B}_{r} = {\vec{B}}_{1} sin α + {\vec{B}}_{2} sin α + {\vec{B}}_{3} \qquad ( 18 )$$

$${B}_{t} = {\vec{B}}_{1} cos α + {\vec{B}}_{2} cos α \qquad ( 19 )$$

where α is the angle between the base of the triangular permeance element and the line connecting the vertex and the midpoint of the opposite side, Bᵣ is the radial magnetic flux density of the triangular permeance, ₜ is the tangential magnetic flux density of the triangular permeance, \ddot{B}₁, \ddot{B}₂, and \ddot{B}, are the magnetic flux densities of the three permeance elements in the triangular permeance elements, respectively.

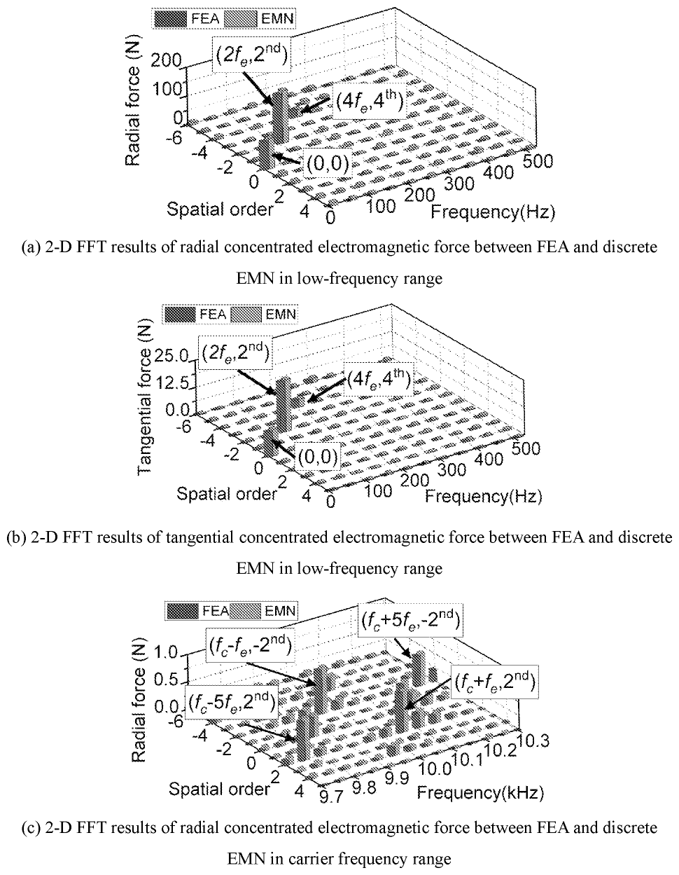

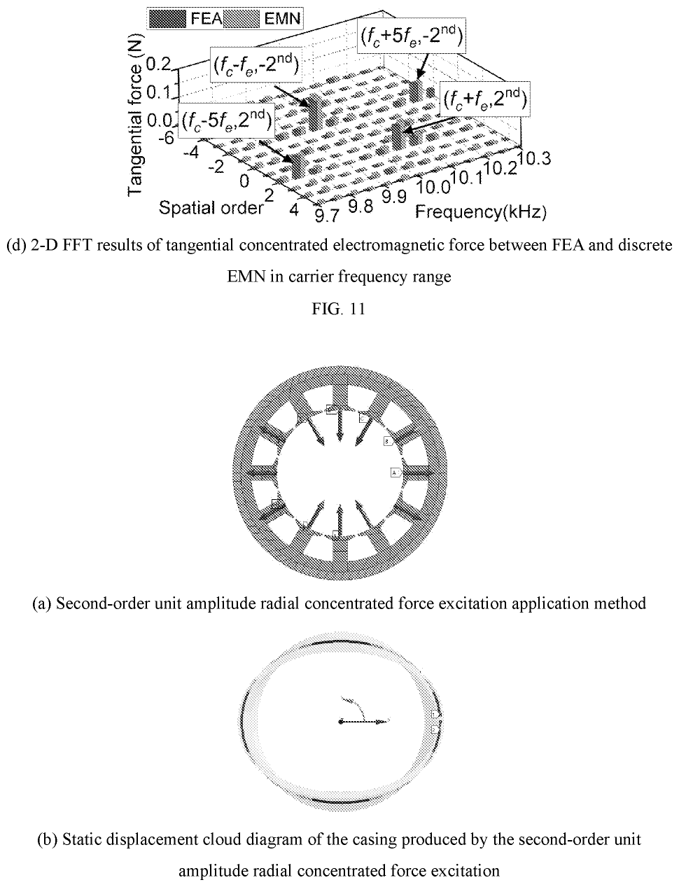

As shown in FIG. 10, the spatial distribution of the solved radial and tangential magnetic flux densities is presented. The magnetic flux density results obtained from the discrete EMN model calculation proposed in the present disclosure are generally close to the FEA results.

Further, the calculated radial and tangential magnetic flux densities are used to compute the radial and tangential electromagnetic force densities as follows:

$$\{ \begin{matrix}{f}_{r} = \frac{{B}_{r}^{2} - {B}_{t}^{2}}{2 {μ}_{0}} \\ {f}_{t} = \frac{{B}_{r} {B}_{t}}{{μ}_{0}}\end{matrix} \qquad ( 20 )$$

where fᵣ represents the radial electromagnetic force density, while fₜ represents the tangential electromagnetic force density.

The radial and tangential electromagnetic force densities obtained by FEA methods or the discrete EMN model proposed in the present invention only approximate all Maxwell forces on the tooth surface. To calculate the vibration response of the SPM machine, it is necessary to compute the concentrated radial force, tangential force, and equivalent moment on the stator tooth surface. Through the force transformation model, the concentrated radial and tangential forces, as well as the equivalent moment, can be expressed as:

$$\{ \begin{matrix}{P}_{r , z} = {L}_{a} {R}_{is} {\int }_{{θ}_{z} - Δ θ / 2}^{{θ}_{z} + Δθ / 2} [ {f}_{r} cos ( {θ}_{z} - θ ) + {f}_{t} sin ( {θ}_{z} - θ ) ] d θ \\ {p}_{t , z} = {L}_{a} {R}_{is} {\int }_{{θ}_{z} - Δθ / 2}^{{θ}_{z} + Δθ / 2} [ {f}_{t} cos ( {θ}_{z} - θ ) + {f}_{r} sin ( {θ}_{z} - θ ) ] d θ \\ {M}_{r , z} = {L}_{a} {R}_{is}^{2} {\int }_{{θ}_{z} - Δθ}^{{θ}_{z} + Δθ} [ {f}_{r} sin ( {θ}_{z} - θ ) - {f}_{t} cos ( {θ}_{z} - θ ) + {f}_{t} ] d θ\end{matrix} \qquad ( 21 )$$

where P_{r,z} is the radial concentrated force of the z^{th}-tooth, P_{t,z} is the tangential concentrated force of the z^{th}-tooth, M_{r,z} is the moment of the z^{th}-tooth, Rᵢₛ is the stator inner radius, θ_{z} is the angle of the central line of the z^{th}-stator tooth, Δθ is the angle between adjacent central lines of two teeth, and θ is the spatial position angle.

As shown in FIG. 11, the two-dimensional Fourier decomposition results of low-frequency and high-frequency electromagnetic forces obtained through the force transmission model are compared. It can be observed that the proposed discrete EMN model is consistent with the electromagnetic force orders and frequency components calculated by the finite element method, with a maximum error of less than 5%.

Step 5: Solve the specific order modal shapes and modal frequencies of the stator, winding, and casing structures of the SPM machine and construct the frequency response function of the SPM machine considering the primary electromagnetic force harmonics.

The modal frequencies of the main modal orders are obtained based on the simulated modal characteristics of the SPM machine, considering the structural dimensions, material properties, and assembly methods. Considering the electromagnetic force modulation effect, the maximum modal order selected is half of the slot number, and the modal orders align with the main orders of electromagnetic forces. For the 12-slo/10-pole SPM machine modeled in the present invention, the main modal orders of interest are 0^{th}, 2^{nd}, 4^{th}, and 6^{th}, as these correspond to the main electromagnetic force orders after considering the electromagnetic force modulation effect. After obtaining the modal frequencies for each modal order through simulation, the corresponding frequency response function can be represented as:

$${H}_{v} ( ω ) = \frac{1}{1 - {( ω / {ω}_{v} )}^{2} + j 2 {η}_{v} ω / {ω}_{v}} \qquad ( 22 )$$

where Hᵥ(ψ) is the frequency response function of the v^{th} modal order, where ψ is the angular frequency, ψᵥ is the modal frequency of the v^{th} modal order, ηᵥ is the damping ratio of the v^{th} modal order, and j is the imaginary unit.

Step 6: Establish the constraints of the SPM machine, apply unit concentrated forces of the primary orders on the circumferential surface of the stator teeth, solve for the displacement at surface measurement points of the SPM machine, and construct the static displacement function of the SPM machine.

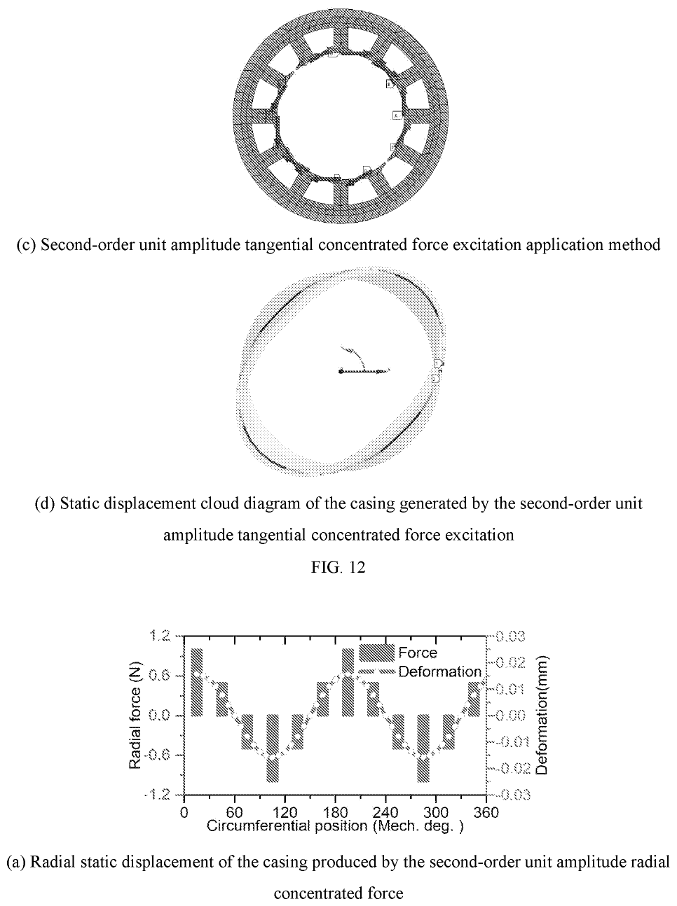

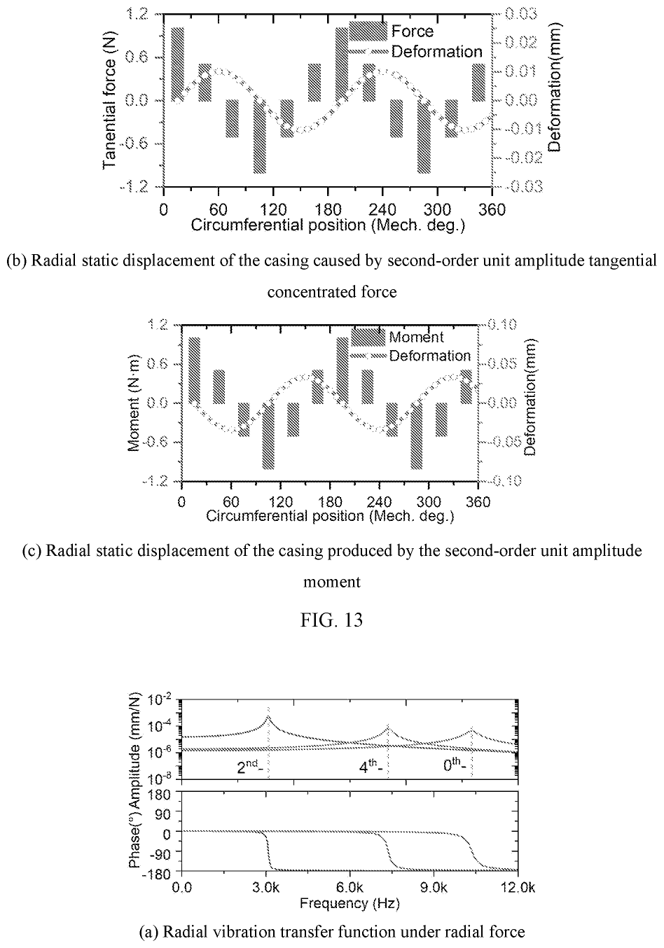

Conduct a simulation of the static displacement of the SPM machine under specific excitations based on the structural dimensions, material properties, and assembly methods of the SPM machine. As shown in FIG. 12, apply unit radial and tangential concentrated forces, as well as moment, of a specific order with an amplitude of IN on the entire stator tooth surface of the motor. Obtain the resulting radial displacement in the circumferential direction of the casing and determine its maximum displacement amplitude. Represent this process as the displacement function of the casing of the SPM machine can be expressed as:

$${D}_{α , v} = {d}_{α , v} sin ( v θ + {φ}_{α , v} ) , α = 1 , 2 , 3 \qquad ( 23 )$$

where D_{α, v} represents the radial displacement function of the SPM machine, where α=1, 2, 3 corresponds to radial, tangential, and moment actions, respectively, and v denotes the order. d_{α, v} is the maximum static radial displacement of the casing under the v^{th}-order excitation of type α. The angles φ_{α, v} are 0°, 90°, and −90° for a equal to 1, 2, and 3, respectively. For the 12-slot/10-pole SPM machine studied in the present invention, the radial shape functions of the casing under the second-order unit radial and tangential concentrated forces, as well as the second-order unit moment, can be represented as shown in FIG. 13. Based on that, the static displacement functions for other orders can be obtained.

Step 7: Multiply the frequency response function and static displacement function of the SPM machine according to their corresponding orders to obtain the vibration transfer function of the SPM machine.

The vibration transfer function of the radial vibration displacement of the SPM machine can be obtained by multiplying the frequency response function and static displacement function obtained in Steps 5 and 6, as shown in FIG. 13. It can be expressed as:

$${T}_{α , v} ( ω ) = {D}_{α , v} {H}_{v} ( ω ) \qquad ( 24 )$$

where T_{α, v} represents the vibration transfer function, where α=1, 2, 3 represents the effects of radial, tangential, and moment excitations, and v represents the order.

Take the concentrated electromagnetic forces obtained from the discrete EMN model and use them to solve the vibration displacement, velocity, and acceleration of the SPM machine at the measurement point in the vibration transfer function.

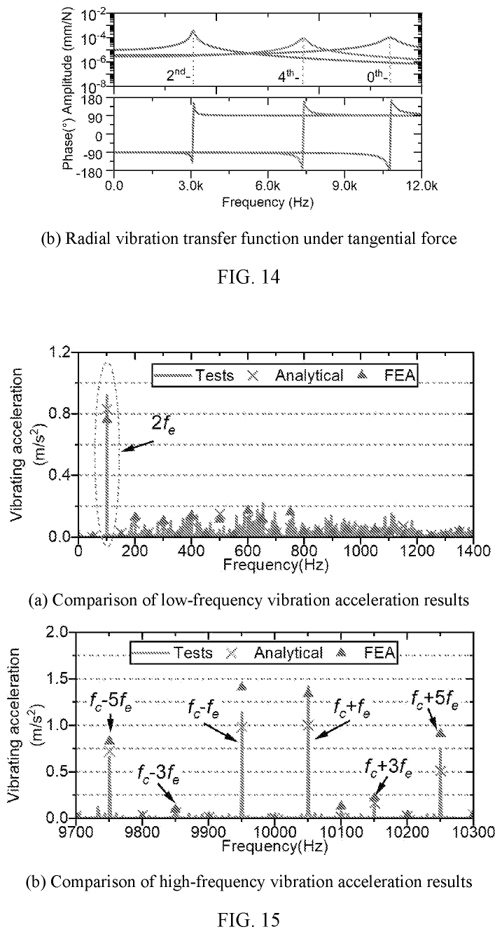

After obtaining the vibration transfer function of the SPM machine, the concentrated radial and tangential electromagnetic forces, as well as the equivalent moment obtained in Step 4, can be multiplied by the corresponding order of the vibration transfer function obtained in Step 7, as shown in FIG. 14. This allows for the calculation of the radial vibration displacement, vibration velocity, and vibration acceleration on the casing surface of SPM machine, represented as follows:

$$Y = {P}_{r , z} {T}_{1 , v} ( ω ) + {P}_{t , z} {T}_{2 , v} ( ω ) + {M}_{r , z} {T}_{3 , v} ( ω ) \qquad ( 25 )$$

$$x = dY / dt = j ω Y \qquad ( 26 )$$

$$a = dx / dt = - {ω}^{2} Y \qquad ( 27 )$$

where Y represents the radial vibration displacement on the casing surface, x denotes the vibration velocity, and a represents the vibration acceleration.

The final calculation results are shown in FIG. 15. By comparing with the results of FEA and experimental testing, it can be demonstrated that the proposed method in the present invention, combining discrete EMN model with vibration transfer functions, provides accurate calculations of vibration acceleration for both low and high frequencies in the SPM machine.

In summary, the modeling method for electromagnetic force and vibration of the SPM machine, based on the discrete EMN model and vibration transfer function, involves establishing a discrete EMN model based on permeance elements for the stator poles, slots, and air gaps of the SPM machine. A regular magnetic circuit model is developed for the stator teeth and yoke, and a discrete equivalent magnetic source and mixed EMN model are created for the rotor magnetic poles and core. The various regional models are then connected based on the structural topology spatial relationships to build the discrete EMN model of the SPM machine. The global nonlinear matrix equation is solved jointly to obtain the magnetic flux density at the air gap mesh nodes and calculate the electromagnetic force density in the air gap. The electromagnetic force density is then converted into concentrated forces, and, based on the modal and static displacement characteristics of the SPM machine structure, the vibration transfer functions are obtained. Finally, vibration calculations are performed using the electromagnetic forces calculated by the discrete EMN model and vibration transfer functions. The provided solution can serve as a reference for calculating electromagnetic field and structural vibration responses for this type of SPM machine.

While the invention has been described regarding the preferred embodiments as disclosed, the embodiments are not intended to limit the scope of the invention. Any equivalent changes or modifications made within the spirit and scope of the invention are within the protection scope defined by the attached claims.

What is claimed is:

1. A method for modeling an electromagnetic force and vibration of an surface-mounted permanent magnet (SPM) machine based on a discrete equivalent magnetic network (EMN) model and vibration transfer function, comprising the following steps:
Step 1: establishing a periodic mixed EMN model for a stator core, a uniform air-gap region, and slot locations based on magnetic symmetry characteristics of the SPM machine;
Step 2: establishing a periodic discrete EMN model for a rotor core, a permanent magnet, and uneven air-gap regions based on the magnetic symmetry of the SPM machine;
Step 3: connecting the periodic mixed EMN model with the periodic discrete EMN according to node mapping principles, setting physical boundary conditions for nodes at periodic boundaries, introducing non-sinusoidal high-frequency current harmonics as input excitation of the EMN model, and establishing and solving a global nonlinear matrix equation;
Step 4: calculating an electromagnetic force density in an air gap of the SPM machine using radial and tangential magnetic flux densities of each permeance of the EMN model in the air gap, and transferring these forces densities to concentrated forces acting on stator teeth based on force transformation principles;
Step 5: solving specific order modal shapes and modal frequencies of the stator core, winding, and casing structure, and constructing a frequency response function of the SPM machine, whose orders are the same as main electromagnetic force harmonic orders of the SPM machine;
Step 6: establishing constraints of the SPM machine, applying unit-wave concentrated forces with main harmonic orders on a circumferential surface of the stator teeth, solving for a vibration displacement at surface measurement points, and constructing a static displacement function of the SPM machine;
Step 7: multiplying the frequency response function of the SPM machine by the static displacement function according to corresponding orders to obtain the vibration transfer function of the SPM machine; and
Step 8: incorporating the concentrated electromagnetic forces obtained from the discrete EMN model into the vibration transfer function of the SPM machine to solve the vibration displacement, velocity, and acceleration at measurement points on the surface of the SPM machine;

2. The method according to claim 1, wherein the SPM machine is a three-phase 12-slot/10-pole machine with surface-mounted eccentric magnetic magnet comprising a stator, air gap, rotor, and casing, the stator includes a stator yoke, stator tooth, stator pole shoe, and armature winding in a slot; the stator core material is non-oriented silicon steel sheets, and the armature winding is a fractional-slot concentrated winding with temperature-resistant enamel-coated wire; the air gap is an irregular air region between the stator tooth surface and the rotor permanent magnet surface, the rotor consists of rare-earth permanent magnets and a rotor core, the rotor permanent magnet is designed eccentrically, with an arc-shaped surface pasted onto the rotor core surface; the rotor core is made by stacking non-oriented 0.2 mm silicon steel sheets, with holes around the rotor core circumference to reduce weight, the casing is made of aluminum alloy material, with an interference fit with the stator, and has a cylindrical shape.

3. The method according to claim 1, wherein of Step 1 further comprises:
based on the slot-pole combination and magnetic circuit characteristics of the SPM machine, determining a distribution of magnetic flux lines, calculating a number of symmetric magnetic circuits of the SPM machine based on the slot-pole combination, determining a complete magnetic circuit region in the stator, the air gap, permanent magnet, and rotor areas, establishing the circuit-based permeance method for a stator yoke area between every two stator teeth in a complete magnetic circuit region, dividing the stator tooth area using rectangular permeance, and modeling the stator pole shoe area and the slot area between two pole shoes using a combination of rectangular and triangular permeances.

4. The method according to claim 1, wherein Step 2 further comprises:
based on the distribution of a complete magnetic circuit in the SPM machine, determining the modeling regions for the air gap, permanent magnet, and rotor core, dividing the irregular air gap and permanent magnet regions into three areas, wherein Area 1 is a regular annular region from the stator tooth surface to the highest point on the permanent magnet surface, Area 2 is the permanent magnet and the gap region between them, and Area 3 is the rotor core region; for Area 1, a size-variable isosceles triangle permeance element is used for at least four subdivision layers, with triangles arranged alternately; for Area 2, the rectangular permeance element is used to mesh, consisting of one permeance and one equivalent magnetic potential source, and the value of the equivalent magnetic potential source is determined by the effective height of the permanent magnet in this region at different solving times; and for Area 3, the Area 3 is divided using the permeance element, with a width of each permeance element matching the rectangular permeance element in Area 2 and each permeance element consisting of two permeances in a series.

5. The method according to claim 1, wherein Step 3 further comprises:
connecting the nodes of the permeance in the circumferential direction of the stator yoke in sequence according to the tangential arrangement, connecting these nodes with corresponding uppermost permeance nodes in the stator tooth area below, connecting the permeance element in the stator tooth area within the core region in sequence, selecting upper and lower nodes in the middle position as equivalent winding magnetic potential source nodes, connecting a lowermost permeance node in the stator tooth area to the uppermost permeance node at the pole shoe, connecting the permeance nodes at the stator tooth surface to the multi-layer triangular permeances in the uniform air gap region, connecting the lowermost permeance in the uniform air gap region to the discretized permeance region of the rotor, establishing a solution matrix based on the number of permeances of the discrete EMN model and connectivity of the overall model, determining labels for the iron core region requiring permeance update calculations.

6. The method according to claim 1, wherein -Step 4 further comprises:
based on the results of the overall magnetic network model, obtaining a magnetic flux density of each layer of permeances in the uniform air gap region, selecting one layer of permeance and, according to the magnetic density values of the three permeances in each triangular element and their geometric spatial positions, calculating the equivalent radial and tangential magnetic densities for each triangular element using the vector addition principle, calculating radial and tangential electromagnetic force densities along the circumference of the air gap based on Maxwell's stress tensor equation, applying an electromagnetic force transfer model to convert the calculated node electromagnetic force density into concentrated radial and tangential forces and equivalent moment acting on the stator tooth surface.

7. The method according to claim 1, wherein Step 5 further comprises:
based on electromagnetic topology design parameters and mechanical structure design parameters of the SPM machine, establishing a structural model considering actual motor installation conditions, including the stator core and casing, calculating the stator Young's modulus, Poisson's ratio, and equivalent density under orthogonal anisotropy based on the thickness of the stator silicon steel sheet, treating a phase winding as an additional mass attached to the stator core, considering the influence of winding impregnation on the stator stiffness, conducting a modal analysis of the constructed structural model, calculating modal orders and their modal frequencies, and construct the frequency response function of the SPM machine.

8. The method according to claim 1, wherein Step 6 further comprises:
based on the spatial position angles of each centerline in the stator, construct concentrated forces of amplitude 1 N for the main orders in the radial and tangential directions, and a moment of amplitude 1 N.m, applying these forces and moment individually to each tooth surface of the stator, setting constraint conditions based on actual installation constraints of the SPM machine and solving for a static deformation at the axial centerline of the casing under the action of each concentrated force and moment, dividing the obtained static deformation distributed by spatial position by the applied unit excitation to obtain the static deformation function for each order force and moment.

9. The method according to claim 1, wherein Step 7 further comprises:
multiplying the frequency response and static deformation function obtained in Steps 5 and 6 for each order to obtain the vibration transfer function from concentrated forces and moment to the surface vibration of the casing of the SPM machine.

10. The method according to claim 1, wherein Step 8 further comprises:
substituting radial and tangential concentrated electromagnetic forces and the moment obtained in Step 4 into the vibration transfer function obtained in Step 7, this allowing the calculation of the surface vibration displacement of the casing in a frequency domain of the SPM machine, based on the conversion relationship between frequency domain displacement, vibration velocity, and vibration acceleration, calculating the vibration acceleration of the SPM machine, and completing the vibration calculation.
